(19) United States
(12) Patent Application Publication
(10) Pub. No.: US 2009/0325763 A1
(43) Pub. Date: Dec. 31, 2009

(54) MULTI-GROUP TRANSMISSION OF A MOTOR VEHICLE

(75) Inventors: Alan DITTRICH, Konstanz (DE); Rayk HOFFMANN, Friedrichshafen (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/490,499

(22) Filed: Jun. 24, 2009

(30) Foreign Application Priority Data
Jun. 30, 2008 (DE) 10 2008 002 750.2

(51) Int. Cl. B60W 10/04; F16H 3/44; F16H 57/08; B60W 30/18

(52) U.S. Cl. 477/109; 475/269; 475/218

(57) ABSTRACT

A transmission of a vehicle and a method for its operation. The transmission has a range group arranged downstream from a main group. The main group output couples a sun gear and a transmission output to a planetary gear carrier of the range group, with a starting element and a change-under-load device, which is integrated in the range group for engaging a traction-force-supporting direct intermediate gear during a gearshift, to connect the transmission input and output shafts. An input component of the change-under-load device is connected to the transmission input shaft and an output component of the change-under-load device is connected to the planetary gear carrier. To increase the efficiency of drive during gearshifts at least one change-under-load device is provided for engaging at least one gear of the main group and/or at least one constant positioned upstream from the main group, which enables shifting under at least partial load.

This application claims priority from German patent application serial no. 10 2008 002 750.2 filed Jun. 30, 2008.

### FIELD OF THE INVENTION

The invention concerns a multi-group transmission of a motor vehicle and a method for operating a multi-group transmission of a motor vehicle.

### BACKGROUND OF THE INVENTION

Multi-group transmissions consist of two or more transmission groups, usually arranged in series, the combining of which produces a large number of gears. Increasingly, they are designed as automated gearshift transmissions consisting of, for example an input group, a main group and a downstream range group. Such transmissions are used particularly in utility vehicles since they provide an especially fine gradation of gears, for example 12 or 16 gears, and are highly efficient. For a smaller number of gears configurations with only a main group and an input group or a main group and a range group are also possible. Furthermore, compared with manual gearshift transmissions they are characterized by high operating comfort and, compared with automatic transmissions, their production and operating costs are particularly economical.

By virtue of their structure conventional multi-group gearshift transmissions, like all manual or automated gearshift transmissions not shifted under load, undergo a traction force interruption during gearshifts since the force flow from the drive motor is always interrupted by disengaging a clutch in order to disengage the engaged gear without load, to synchronize the transmission and the drive motor in a neutral position to a connection speed, and then to engage the target gear. Since the vehicle is rolling during the traction force interruption undesired speed increases or speed decreases can occur. In addition the fuel consumption can increase. Whereas with passenger motor vehicles the traction force interruption, which affects the driving dynamics, is as a rule perceived only as annoying, for example during upshifts in a driving style of sporty orientation, in the case of medium-weight or heavy utility vehicles the driving speed can be reduced to the point where an upshift is made impossible and, on uphill stretches, undesired downshifts, creep-driving or even additional starting operations may be necessary.

From DE 10 2006 024 370 A1 by the present applicant an automated multi-group change-speed transmission of a motor vehicle with traction force support during gearshift operations is known. The transmission comprises a splitter group with a transmission input shaft as its input or upstream transmission, a main group with a main transmission shaft as its basic transmission and a range group with a transmission output shaft on the output side as its output or downstream transmission. The drive motor can be connected to the transmission input shaft in the conventional way, by a starting element. The design of this known multi-group transmission with an input group and a main group enables a direct gear to be engaged as an intermediate gear during a gearshift operation. To do this, by means of a change-under-load clutch made as a friction clutch a direct connection is formed temporarily between the transmission input shaft and the main transmission shaft, the latter being for its part actively connected to the transmission output shaft. This renders the main transmission and the splitter group free from load so that the gear engaged can be disengaged, the transmission synchronized and the target gear engaged, without having to disengage the starting clutch during the gearshift. During this the change-under-load clutch transmits motor torque to the transmission output and dynamic torque that is released by the speed adaptation between the original gear and the target gear is used in order to compensate the traction force interruption to a large extent. The change-under-load clutch acting as the intermediate-gear clutch can be arranged between the input transmission and the main transmission or between the starting clutch and the input transmission. A shift of the downstream range group between a lower gear range and an upper gear range during a gearshift operation is not, however, inherently traction-force-supported.

DE 10 2005 046 894 A1 by the present applicant shows a multi-group transmission of a motor vehicle with a main group and a downstream range group, in which a change-under-load clutch made as a friction clutch is arranged within the range group to support the traction force during a gearshift. The range group is designed as a planetary gear set whose sun gear is connected to an output shaft of the main group and whose planetary gear carrier is connected to a transmission output shaft on the transmission output side. A transmission input shaft can be connected to the drive motor of the vehicle by means of a starting clutch. The transmission input shaft is extended through the main group as far as the range transmission and connected at its end to the input side of the change-under-load clutch. The output side of the change-under-load clutch can either be connected, via the output shaft of the main group, to the sun gear, or coupled, via the planetary gear carrier, directly to the transmission output shaft. By means of the change-under-load clutch a controllable direct connection can be made between the transmission input shaft and the transmission output shaft, which in a manner comparable to DE 10 2006 024 370 A1, can be used during a gearshift operation to unload the main transmission and carry out the gearshift with the starting element closed, without interrupting the traction force. Whereas in the first version, the force flow first branches via the range group, the second version, in which the output side of the change-under-load clutch is connected directly to the planetary gear carrier and thus to the transmission output, has the advantage that gearshift operations that include a range change in the range group are also traction-force-supported. The multi-group transmissions disclosed in both of the documents cited are capable of fulfilling their set objectives completely and enabling traction-force-supported gearshifts. Nevertheless, it is desirable for the dynamics during gearshift operations in such automated group transmissions to be improved still further.

### SUMMARY OF THE INVENTION

Against this background, the purpose of the present invention is to indicate a multi-group transmission with intermediate gear engagement and a method for its operation which, particularly in relation to the efficiency of traction force support during gearshifts, are improved and achieve the greatest possible shifting comfort.

The invention is based on the recognition that in an automated multi-group change-speed transmission with traction force support during traction upshifts and traction downshifts, the time taken to engage an intermediate gear can be made shorter by means of additional change-under-load gearshift elements which allow the actuation of the gearshift operation to be initiated already when approaching speed equalization between the shift partners involved.

Accordingly, the invention starts from a multi-group transmission of a motor vehicle, with at least two transmission groups such that a range group designed as a planetary gear set, is positioned downstream from a main group, designed as a gear transmission, a main group output shaft being connected to a sun gear and a transmission output shaft being connected to a planetary gear carrier of the range group, with a starting element by means of which a drive motor can be connected to a transmission input shaft, and with change-under-load means made as a friction clutch integrated in the range group for engaging a traction-force-supporting direct gear as an intermediate gear during a gearshift operation, by means of which the transmission input shaft can be connected to the transmission output shaft, an input component of the change-under-load means being connected to the transmission input shaft and an output component of the change-under-load means being connected to the planetary gear carrier.

To achieve the stated objective, the invention also provides that in addition to the change-under-load means for engaging an intermediate gear at least one change-under-load device for engaging at least one gear of the main group and/or at least one constant upstream from the main group is provided, which allows shift processes to take place at least under partial load.

A gearshift operation is understood to be a shift process in which an original gear is disengaged and a target gear is engaged, including also the special case when the target gear and the original gear are one and the same so that no actual transmission ratio change takes place. Furthermore, of the individual transmission groups an upstream splitter group is also referred to as a splitter transmission, a main group also as a main transmission and a downstream range group as a range transmission.

The invention also starts from a method for operating a multi-group transmission of a motor vehicle, in which traction-force-supporting means are activated during a gearshift operation. The set objective relating to the method is achieved in that by virtue of change-under-load means that act as a friction clutch an intermediate gear is engaged, in which a connection is formed between a transmission input shaft and a transmission output shaft, so that a starting element remains at least partially closed and the change-under-load means, operating at least in a slipping condition, supports a torque of a drive motor at the transmission output shaft while the speed of the drive motor is adapted to a synchronous speed of a target gear, in such manner that with the help of at least one change-under-load device that can be shifted at least partially under load for shifting an original gear and/or a target gear, the original gear is disengaged and/or the target gear is engaged already when the load-free condition has nearly been reached and/or the synchronous speed has nearly been reached.

In a preferred embodiment of the invention, besides the main group and the downstream range group an upstream splitter group is provided, so that a total of three transmission groups are arranged in the force flow one after another, the splitter group with two constants and the main group with at least three gears being made as a transmission of countershaft design with at least one common countershaft. Owing to its fine gradation of gears and its great shifting comfort, such a transmission can be used to particularly good advantage in utility vehicles.

Preferably, such a transmission is designed with two countershafts mounted parallel to the transmission input shaft, via which the power of the splitter group and the main group branches, such that in each gearset a loose wheel fitted coaxially with the transmission input shaft engages with associated fixed wheels respectively mounted on the countershafts. However, the invention can also be implemented advantageously in the case of countershaft transmissions with only one countershaft, or other group transmissions.

In such a transmission, if the main group has three gears the total number of forward gears obtained is n=n_{GV}×n_{HG}×n_{GP}=2×3×2=12. Correspondingly, with a four-gear main group 16 forward gears are possible. An associated shift sequence can for example provide that first, via the constants of the splitter transmission the gear steps of the main group are varied in alternation and multiplied by a gear ratio of the range transmission. After a range change, the same variation can be repeated but without any imposed planetary gear ratio.

With the arrangement in which it passes through the transmission groups, the transmission input shaft is extended up to the input of the range group, and an output shaft of the main transmission, on which are seated the shifting devices of the main transmission's gears, made according to the invention as change-under-load devices, and which supports at its end the sun gear of the range group, can be made as an outer, hollow shaft through which the transmission input shaft passes coaxially as an inner shaft. At its end the transmission input shaft is connected to an input side of the intermediate-gear clutch. An output side of the intermediate-gear clutch is connected to the planetary gear carrier.

In a space-saving manner the intermediate-gear clutch can be positioned inside the planetary carrier coaxially behind the sun gear, so that only this area has to be structurally adapted to accommodate the intermediate-gear clutch. As the intermediate-gear clutch a controllable friction clutch is provided, which can in principle be of single or multi-disk structure. Particularly advantageous, for example, is to use a wet-operating disk clutch as the intermediate-gear clutch.

By virtue of the arrangement of the intermediate-gear clutch on the transmission output the intermediate gear is designed as a direct gear of the transmission as a whole independently of the current gear range setting of the range group, since the drive motor can be connected directly to the transmission output shaft by means of the intermediate-gear clutch. Consequently, a range change during a gearshift operation with intermediate gear engagement is also automatically traction-force-supported.

Whereas, already due to the intermediate gear engagement in itself, during all traction gearshifts the loss of speed is reduced significantly and, compared with conventional gearshifts with traction force interruption, shifting times are shorter with the result that driving performance is enhanced and the shifting and driving comfort are increased, with the help of change-under-load shift elements in change-under-load devices on the gearsets the traction-force-supported gearshifts take even less time, whereby still better driving performance and shifting and driving comfort are obtained. Also, since slipping operation in the intermediate gear takes place for a shorter time on average, the intermediate-gear clutch undergoes less wear and this has a cost-reducing effect on the design of the intermediate-gear clutch and extends its life.

Moreover, by means of the intermediate gear, the rotating masses to be synchronized can be braked, whereby the transmission brake usually provided for braking those masses during upshift operations can be omitted, so saving further costs and saving or reducing both structural space and weight. In addition oscillations and jerky shifts are effectively reduced since the drivetrain remains stressed due to the intermediate gear throughout the gearshift operation, and this results in an additional increase of the shifting comfort

The traction force support by the intermediate gear functions as follows:

By engaging the intermediate gear during a gearshift operation, the main group and the splitter group in the force flow are relieved from load and can therefore be shifted, whereas the starting clutch preferably remains fully engaged during the shift process so as to ensure the most effective possible maintenance of the traction force. By means of the friction clutch integrated in the range group, the intermediate gear can be engaged as a direct gear of the transmission as a whole, i.e. as a direct connection between the transmission input shaft and the transmission output shaft. During this, the friction clutch, operating in a slipping condition, transmits the motor torque to the drive output or the driven vehicle wheels throughout the traction upshift or traction downshift, while the motor speed is adapted to the target gear. Thus, a torque that is released due to the motor speed adaptation can be used for maintaining the traction force. To complete the gearshift operation the intermediate gear is disengaged again. In principle, with a gear change of this type—and particularly, in contrast to the known double-clutch transmissions—traction-force-supported gear intervals over two or more gear steps are made possible.

With a traction-force-supported gearshift of this type in an automated change-speed transmission, without further measures the main transmission and the splitter transmission can only be brought to their neutral position and the target gear can only be engaged when the transmission groups to be shifted are at least almost free from load and the motor and transmission are synchronized at a connection speed. However, with the arrangement according to the invention, comprising shift elements that can be changed under load or under partial load to engage the loose wheels of the gearsets, the necessary shifting times can advantageously be made shorter because by virtue of such shifting aids, engagement and/or disengagement processes can be initiated or carried out already while there are still small speed differences between the drive input and output, without increased wear or detriment to comfort.

In particular, it can be provided that at least one change-under-load device comprises at least one friction clutch and/or that at least one change-under-load device comprises at least one change-under-load claw. As clutch elements, for example simply controlled single-disk elements or claws with suitable friction surfaces can be used.

If such a change-under-load device is arranged on only one gearset, then the shift processes shortened will be those in which the gearset concerned is involved. Consequently it makes sense to arrange change-under-load devices if possible on all the gearsets of the main transmission and splitter transmission, so that all the relevant shift processes can be correspondingly shortened.

In a particularly advantageous change-under-load device, two diametrically opposed friction clutches are arranged axially between the two constants of the splitter group, the two friction clutches having a common input component connected in a rotationally fixed manner to the transmission input shaft and each clutch having a respective output component connected to a loose wheel of the constant close to the motor and to a loose wheel of the constant remote from the motor, so that via the friction clutches a drive connection can be engaged, at least under partial load, between the transmission input shaft and the at least one countershaft, in which at least one rotationally fixed connection of a loose wheel to the transmission input shaft is formed or released. Such a change-under-load device replaces for example a usual, synchronized shift device, i.e. a two-sided synchronous clutch of the splitter group.

Furthermore, a change-under-load device with two diametrically opposed friction clutches can be arranged axially between the splitter group constant remote from the motor and a main transmission gear, the two friction clutches having a common output component connected in a rotationally fixed manner to the output shaft of the main group and each clutch having a respective input component connected to a loose wheel of the constant remote from the motor and to a loose wheel of the main transmission gear, so that via the friction clutches a drive connection can be engaged, at least under partial load, between the at least one countershaft and the output shaft of the main group, in which at least one rotationally fixed connection of a loose wheel to the output shaft of the main group is formed or released. Such a change-under-load replaces for example a usual, unsynchronized claw-type shift device of the main group.

The change-under-load devices that can be engaged on both sides have a particularly compact and weight-saving structure. Of course, however, particularly with an uneven number of forward-gear gearsets in the main transmission, change-under-load devices with only one friction clutch, i.e. change-under-load devices which only engage on one side, can be arranged on one or more main transmission gears or even on constants of the splitter group.

In an analogous manner it can be provided that a change-under-load device with a two-sided, alternately operating change-under-load claw rotationally fixed to the transmission input shaft is arranged between the two constants of the splitter group, so that by means of this change-under-load claw a drive connection can be engaged, at least under partial load, between the transmission input shaft and the at least one countershaft, in which at least one rotationally fixed connection of a loose wheel of the constant close to the motor, or of a loose wheel of the constant remote from the motor, to the transmission input shaft is formed or released.

Correspondingly, if a change-under-load device with a two-sided, alternately operating change-under-load claw rotationally fixed to the output shaft of the main group is arranged axially between the splitter group constant remote from the motor and a main transmission gear, a drive connection can be engaged, at least under partial load, between the at least one countershaft and the output shaft of the main group, in which at least one rotationally fixed connection of a loose wheel of the constant remote from the motor or of a loose wheel of the main transmission gear to the output shaft of the main group is formed or released. Finally of course, change-under-load devices with change-under-load claws that can be shifted under load on one side only can be provided in the main transmission or in the splitter transmission.

### BRIEF DESCRIPTION OF THE DRAWINGS

To clarify the invention, the description of drawings with two example embodiments is attached. The drawings shows:

FIG. 1: Transmission layout of an automated multi-group transmission of a motor vehicle with an intermediate-gear clutch integrated in a range group and with conventional gearshift devices that cannot be changed under load

FIG. 2: Transmission layout of an automated multi-group transmission of a motor vehicle with an intermediate-gear clutch integrated in a range group and with change-under-load gearshift devices according to the invention, and

FIG. 3: A second embodiment of a Transmission layout of an automated multi-group transmission of a motor vehicle with an intermediate-gear clutch integrated in a range group and with change-under-load gearshift devices according to the invention

### DETAILED DESCRIPTION OF THE PREFERRED EMBODIMENTS

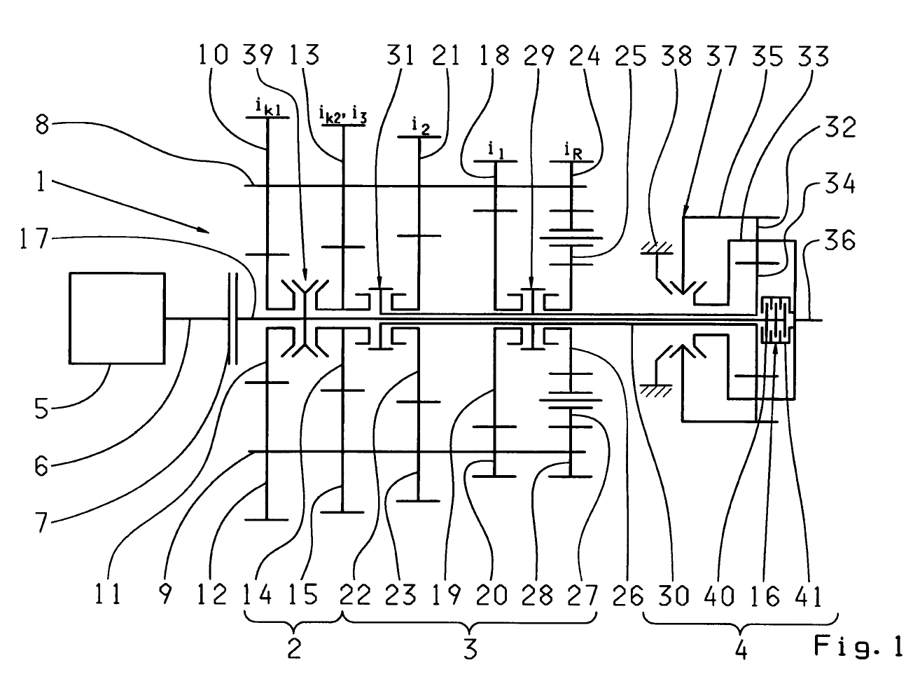

FIG. 1, accordingly, shows an automated multi-group transmission designed as a two-countershaft transmission 1 with two parallel, rotating countershafts 8, 9 and three transmission groups 2, 3, 4 arranged one after another, as can be provided, for example, in the drivetrain of a utility vehicle. On the transmission output is arranged a change-under-load means 16 for engaging an intermediate gear. However, such a transmission, in which an intermediate-gear clutch is arranged between an input group and a main group or between a starting clutch and an input group, is known per se from DE 10 2006 024 370 A1 by the present applicant mentioned at the beginning. A comparable group transmission with an intermediate-gear clutch arranged on the transmission output but with only one countershaft, is known from DE 10 2005 046 894 A1 by the present applicant, also already mentioned. Thus, the invention relates essentially to change-under-load devices 42, 48, 54 and 59, 61, 63 for supporting the intermediate-gear clutch 16 during a gearshift operation.

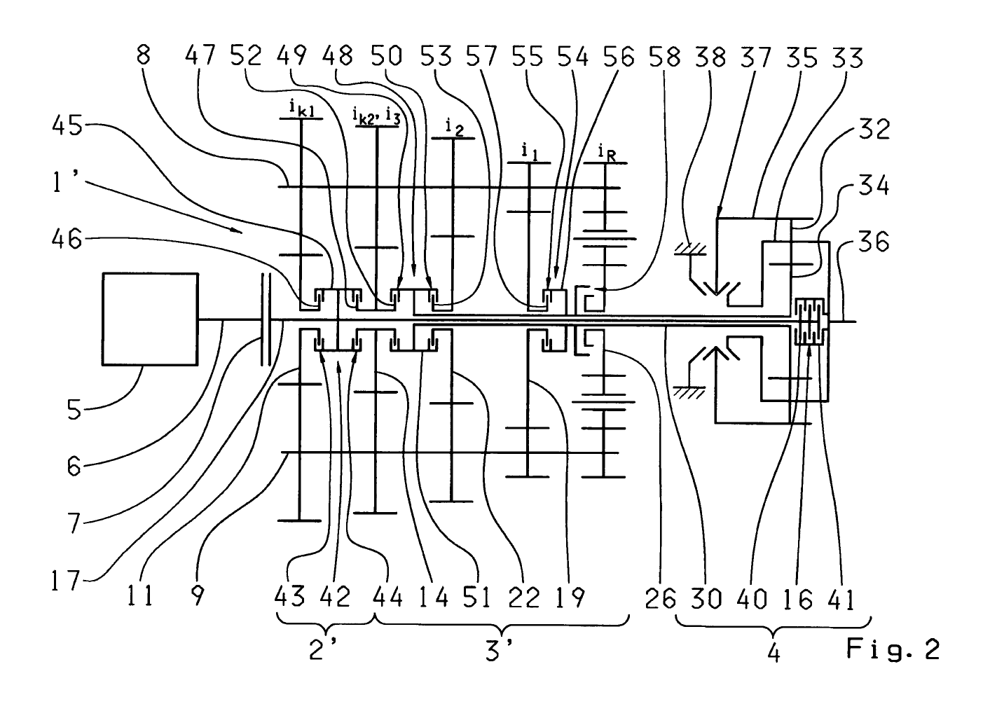

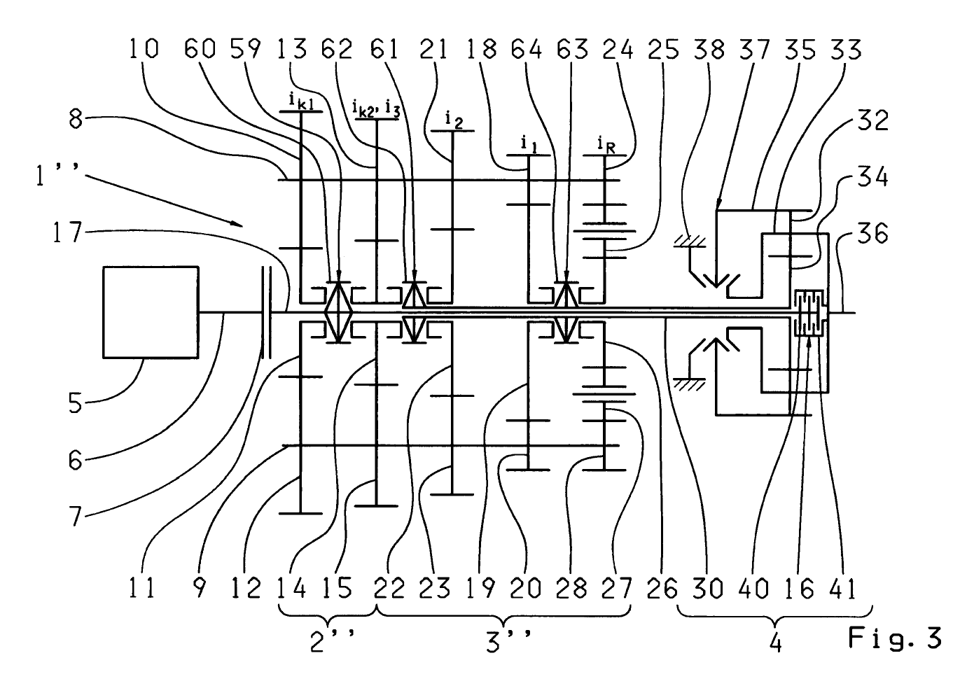

To clarify the invention, in what follows, first the transmission layout in FIG. 1, with conventional shift devices 29, 31, 39 which cannot be changed under load, and then the layouts in FIGS. 2 and 3, with change-under-load shift devices 42, 48, 54 and 59, 61, 63 for engaging the gears, will be described.

A driveshaft 6 of a drive motor 5 can be connected to a transmission input shaft 17 by a conventional starting element 7, for example in the form of a friction clutch. The first transmission group 2, on the input side, is made as a two-gear splitter transmission. The second, central transmission group 3 is formed by a three-gear main or basic transmission. As the third transmission group 4 on the output side, a downstream, two-gear range transmission is arranged.

The splitter group 2 has two constants iₖ₁, iₖ₂, each comprising a fixed wheel arranged rotationally fixed on the first countershaft 8 and on the second countershaft 9, namely 10, 12 and 13, 15 respectively, which mesh with a respective loose wheel 11 or 14. The first constant iₖ₁ faces toward the starting element 7 and the second constant iₖ₂ toward the main transmission 3. To engage the constants iₖ₁, iₖ₂ a shift device 39 is provided, advantageously with synchronization, by means of which the loose wheels 11 or 14 can be selectively connected in a rotationally fixed manner to the transmission input shaft 17.

The main transmission 3 comprises three forward-gear gearsets i₁, i₂, i₃ and a reverse-gear gearset i_{R}. The 1^{st} and 2^{nd} main transmission gears i₁, i₂ each comprise two fixed wheels, 18, 20 and 21, 23 respectively, and a respective loose wheel 19 or 22. The 3^{rd} main transmission gear i₃ is produced in combination with the second constant iₖ₂ of the splitter group 2. The reverse-gear gearset i_{R} comprises two fixed wheels 24, 28, a loose wheel 26 and two freely rotating intermediate wheels 25, 27 to reverse the rotation direction, which mesh on one side with the respectively associated fixed wheel 24 or 28 and on the other side with the loose wheel 26.

To engage the 1^{st} main transmission gear i₁ and the reverse-gear gearset i_{R} the unsynchronized claw-type shift device 29 is provided, by means of which the associated loose wheels 19 or 26 can selectively be connected rotationally fixed to a main group output shaft 30 made as a hollow shaft.

Further, to engage the 2^{nd} main transmission gear i₂ and the 3^{rd} main transmission gear i₃ the unsynchronized claw-type shift device 31 is provided, by means of which the associated loose wheels 22 or 14 can be selectively connected in a rotationally fixed manner to the main group's output shaft 30. The gears i₁, i₂, i₃, i_{R} of the main transmission 3 transmit the power flow from the countershafts 8, 9 to the main group's output shaft 30 and from there onward in the direction of the transmission output. Since the 3^{rd} main transmission gear i₃ and the second constant iₖ₂ use the same gearset i_{K2}−i₃, the loose wheel 14 of that gearset i_{K2}/i₃ can be connected on the drive input side to the transmission input shaft 17 by the shift device 39 of the splitter group 2 and to the main group's output shaft 30 on the drive output side by the shift device 31 of the main group 3.

The downstream range transmission 4 is made as a planetary transmission, in which a planetary gearset 32 is guided by a planetary gear carrier 33. The planetary gears (not illustrated explicitly) mesh on one side with a central, sun gear 34 and on the other side with an outer, ring gear 35. The sun gear 34 is connected to the main group's output shaft 30. The planetary gear carrier 33, in turn, is connected to a transmission output shaft 36.

To shift the range transmission 4 a shift device 37, advantageously with synchronization, is provided. In a first shift position this shift device 37 connects the ring gear 35 to a housing 38 so that the planetary gears rotate between the ring gear 35 and the sun gear 34, and the transmission output shaft 36 is driven by the planetary gear carrier 33 in the same direction as the output shaft 30 of the main group in accordance with a gear ratio of the planetary transmission. In a second shift position the ring gear 35 is locked to the planetary gear carrier 33 so that the planetary transmission 4, and hence the transmission output shaft 36, rotate directly at the same speed as the main group's output shaft 30.

The intermediate-gear clutch 16 made as a friction clutch is positioned between the sun gear 34 and the transmission output shaft 36. An inner input component 40 of the intermediate-gear clutch 16 is connected to the extended end of the transmission input shaft 17. An outer, pot-like output component 41 is connected at its end to the planetary gear carrier 33 and hence to the transmission output shaft 36. By virtue of usual input-side and output-side co-operating friction surfaces, a direct frictional connection can be formed between the drive input, i.e. the transmission input shaft 17, and the drive output, i.e. the transmission output shaft 36, while the intermediate-gear clutch can be controlled by a clutch and transmission control system (not shown) to operate in slipping mode.

From the combination of the transmission groups 2, 3 and 4 of the transmission layout 1 shown, a total of 2×3×2=12 gears are obtained. The force flow of the transmission 1 branches in accordance with a shift sequence in which, starting with the 1^{st} gear of the main transmission 3, first the splitter group 2 and the main group 3 are shifted through in alternation so that 2×3=6 gears of a lower gear range “1^{st} gear to 6^{th} gear” are obtained one after another. On reaching the 6^{th} gear the range group 4 is shifted and the main group 3 and splitter group 2 are again switched through in alternation, so that once more 2×3=6 gears are obtained, but this time in an upper gear range “7^{th} gear to 12^{th} gear”. In addition, by shifting between the constants iₖ₁, iₖ₂ of the splitter group 2, two reverse gear ratios are available selectively.

In the shift sequence described, in the 6^{th} gear or in the 12^{th} gear the transmission input shaft 17 is connected via the engaged second constant iₖ₂ and the closed 3^{rd} main transmission gear i₃ to the main group's output shaft 30, so that the transmission ratio in 6^{th} gear is i=1 plus the range group ratio, and in the 12^{th} gear i=1 including the range group ratio. However, if the 11^{th} and 12^{th} gears are designed as fast gears with i<1, the shift sequence could also be changed so that already the 10^{th} gear adopts this shift position and is therefore the direct gear.

The direct ratio i=1 also corresponds to the intermediate gear. To engage the intermediate gear designed as the direct gear, as already explained, the extended transmission input shaft 17 can be connected by the intermediate-gear clutch 16 directly to the transmission output shaft 36, so that in contrast to the above described interlocked direct gear, the frictional direct gear can be controlled by operating the intermediate-gear clutch 16 in slipping mode.

FIG. 2 shows a comparable transmission layout 1′ with a splitter group 2′ and a main group 3′ which, instead of the conventional shift devices 29, 31 39, comprise change-under-load shift devices 42, 48, 54 for engaging the forward-gear gearsets i₁, i₂, iₖ₁, iₖ₂. The change-under-load device 42 of the splitter group 2′ comprises two coaxial friction clutches 43 and 44 with a common, outer input component 45 connected to the transmission input shaft 17. The input component 45 encloses an output component 46 connected to the loose wheel 11 of the constant iₖ₁ nearest the motor and an output component 47 opposite it, which is connected to the loose wheel 14 of the constant iₖ₂ remote from the motor. The friction clutches 43 and 44 can be controlled in such manner that it remains possible to shift between the constants iₖ₁, iₖ₂ up to a predetermined, maximum permissible speed difference between the input and output sides, i.e. under partial load.

Between the 3^{rd} main transmission gear i₃ and the 2^{nd} main transmission gear i₂ is arranged a further shift device 48 of largely the same structure, in which, compared with the change-under-load device 42, the input and output sides are exchanged. The change-under-load device 48 of the main group 3′ comprises two coaxial friction clutches 49 and 50 with a common output component 51 connected to the output shaft 30 of the main group. The output component 51 encloses an input component 52 connected to the loose wheel 14 of the 3^{rd} main transmission gear i₃ and the constant iₖ₂, and an opposite component 53 connected to the loose wheel 22 of the 2^{nd} main transmission gear i₂. This change-under-load device 48 enables shift operations of the associated gearsets i₂ and i₃ under partial load. A third change-under-load device 54 is associated with the 1^{st} main transmission gear i₁. This change-under-load device 54 comprises a friction clutch 55 with an outer output component 56 connected to the main group's output shaft 30 and an inner input component 57 connected to the loose wheel 19 of the gear i₁. Finally, for the reverse gear i_{R} a conventional claw-type shift device 58 is provided.

FIG. 3 shows a further transmission layout 1″. In this, change-under-load devices 59, 61, 63 with change-under-load claws 60, 62, 64 (not described further) are arranged in a splitter group 2″ and in a main group 3″. The first two change-under-load claws 60, 62 act in alternation on both sides, such that in each case a change-under-load claw 60, 62 fulfils the functions of two friction clutches 43, 44 or 49, 50 in FIG. 2 in a comparable manner. For the first main transmission gear i₁ and the reverse gear i_{R} a change-under-load claw device 63 is provided, whose change-under-load claw 64 can also be changed under load on both sides. However, this change-under-load claw 64 can also be provided on the side of the reverse gear i_{R} as a simple shifting claw.

A method according to the invention for operating a multi-group transmission as illustrated in FIG. 2 or 3 and described above, is based essentially on the principle that to maintain the traction force during a gearshift operation, an intermediate gear is engaged by means of an intermediate-gear clutch 16 while the starting element 7 remains engaged, and with the help of shift devices 42, 48, 54 or 59, 61, 63 on the gearsets i₁, i₂, iₖ₁, iₖ₂ that can be changed under load or under partial load, shorter shift times are achieved and the time taken for the gearshift operation is made shorter.

When a shift demand is initiated by the driver or by a transmission control system, the intermediate gear is engaged by means of the intermediate-gear clutch 16, i.e. a direct connection is formed between the transmission input shaft 17 and the transmission output shaft 36. As a consequence of the motor torque support at the drive output the main transmission 3′, 3″ is made free from load and can therefore be shifted. While the motor speed approaches the required target gear with the intermediate-gear clutch 16 in slipping operation, already before complete speed equalization of the corresponding shafts has been reached the gearshift operation can be carried out, i.e. by means of the corresponding change-under-load devices 42, 48, 54 or 59, 61, 63 the original gear is disengaged and the target gear is engaged. The starting element 7 remains engaged throughout this shift process.

To complete the gearshift operation the intermediate gear is again disengaged. Depending on the shift process or gearshift operation, the traction-force-supported gearshift can alternatively or additionally involve a shift between the constants iₖ₁, iₖ₂ of the splitter group 2′, 2″, also with change-under-load support, and/or with a gearshift of the range group 4.

### LIST OF INDEXES

1, 1′, 1″ Two-countershaft transmission
2, 2′, 2″ Splitter group, splitter transmission
3, 3′, 3″ Main group, main transmission
4 Range group, range transmission
5 Drive motor
6 Driveshaft
7 Starting element
8 Countershaft
9 Countershaft
10 Fixed wheel
11 Loose wheel
12 Fixed wheel
13 Fixed wheel
14 Loose wheel
15 Fixed wheel
16 Change-under-load means
17 Transmission input shaft
18 Fixed wheel
19 Loose wheel
20 Fixed wheel
21 Fixed wheel
22 Loose wheel
23 Fixed wheel
24 Fixed wheel
25 Intermediate wheel
26 Loose wheel
27 Intermediate wheel
28 Fixed wheel
29 Shift device
30 Output shaft of the main group
31 Shift device
32 Planetary gearset
33 Planetary gear carrier
34 Sun gear
35 Ring gear
36 Transmission output shaft
37 Shift device
38 Housing
39 Shift device
40 Clutch input component
41 Clutch output component
42 Change-under-load device
43 Change-under-load friction clutch
44 Change-under-load friction clutch
45 Change-under-load friction clutch: input component
46 Change-under-load friction clutch: output component
47 Change-under-load friction clutch: output component
48 Change-under-load device
49 Change-under-load friction clutch
50 Change-under-load friction clutch
51 Change-under-load friction clutch: output component
52 Change-under-load friction clutch: input component
53 Change-under-load friction clutch: input component
54 Change-under-load device
55 Change-under-load friction clutch
56 Change-under-load friction clutch: output component
57 Change-under-load friction clutch: input component
58 Claw-type shift device
59 Change-under-load device
60 Change-under-load claw
61 Change-under-load device
62 Change-under-load claw
63 Change-under-load device
64 Change-under-load claw
iₖ₁ Splitter transmission constant
iₖ₂ Splitter transmission constant
i₁ Main transmission gear
i₂ Main transmission gear
i₃ Main transmission gear
i_{R} Main transmission reverse gear

1-12. (canceled)

13. A multi-group transmission of a motor vehicle comprising at least a main group and a range group (3′, 3″, 4), the range group (4) being designed as a planetary gearset and being positioned downstream of the main group (3′, 3″) and designed as a gear transmission;
a main group output shaft (30) being connected to a sun gear (34) of the range group (4) and a transmission output shaft (36) being connected to a planetary gear carrier (33) of the range group (4);
a starting element (7) coupling a drive motor (5) to a transmission input shaft (17);
a change-under-load means (16), designed as a friction clutch, being integrated into the range group (4) for engaging a traction-force-supporting direct gear, as an intermediate gear during a gearshift operation, and the change-under-load means (16) facilitates coupling of the transmission input shaft (17) to the transmission output shaft (36);
an input component (40), of the change-under-load means (16), being connected to the transmission input shaft (17) and an output component (41), of the change-under-load means (16), being connected to the planetary gear carrier (33) of the range group (4);
at least one change-under-load device (42, 48, 54, 59, 61, 63) engaging at least one gear (i₁, i₂, i₃) of the main group (3′, 3″) or at least one constant (iₖ₁, iₖ₂), located upstream of the main group (3′, 3″), to facilitate a gearshift under at least partial load.

14. The multi-group transmission according to claim 13, wherein the at least one change-under-load device (42, 48, 54) comprises at least one friction clutch (43, 44, 49, 50, 55).

15. The multi-group transmission according to claim 13, wherein the at least one change-under-load device (59, 61, 63) comprises at least one change-under-load claw clutch (60, 62, 64).

16. The multi-group transmission according to claim 13, wherein the main group output shaft (30) is a hollow shaft through which the transmission input shaft (17) coaxially passes.

17. The multi-group transmission according to claim 13, wherein a splitter group (2′, 2″) is located on an input side of the transmission and comprises two constants (iₖ₁, iₖ₂), the main group (3′, 3″) is located between the splitter group (2′, 2″) and the range group (4) and comprises at least three gears (i₁, i₂, i₃) and the range group (4) is located on an output side of the transmission and comprises two gear ranges, the splitter group (2′, 2″), the main group (3′, 3″) and the range group (4) are arranged, one after another, in a flow of power, the splitter group (2′, 2″) and the main group (3′, 3″) are each a countershaft transmission with at least one common countershaft, and a respective loose wheel (11, 14, 19, 22) is coaxially supported on the transmission input shaft (17) which engages with respective fixed wheels (10, 12, 13, 15, 18, 20, 21, 23) rotationally fixed on the at least one countershaft (8, 9) which is parallel to the transmission input shaft (17).

18. The multi-group transmission according to claim 17, wherein a change-under-load device (42), with two diametrically opposed friction clutches (43,44), is axially arranged between the two constants (iₖ₁, iₖ₂) of the splitter group (2′), the two friction clutches (43, 44) comprise a common input component (45) which is rotationally fixed to the transmission input shaft (17) and, in each case, an output component (46, 47) is respectively connected to a loose wheel (11) of the constant (iₖ₁) closest the drive motor (5) and to a loose wheel (14) of the constant (iₖ₂) remote from the drive motor (5), the two friction clutches (43, 44) are engagable, under at least partial load, to form a drive connection between the transmission input shaft (17) and the at least one countershaft (8, 9) in which a rotationally fixed connection of one loose wheel (11, 14) to the transmission input shaft (17) is either formed or released.

19. The multi-group transmission according to claim 17, wherein a change-under-load device (48), with two diametrically opposed friction clutches (49,50), is axially arranged between a constant (iₖ₂) of the splitter group (2′) and a main transmission gear (i₂), the two friction clutches (49, 50) comprise a common output component (51) which is rotationally fixed to the output shaft (30) of the main group and, in each case, an input component (52, 53) respectively connected to a loose wheel (14) of the constant (iₖ₂) of the splitter group (2′) remote from the drive motor (5) and to a loose wheel (22) of the main transmission gear (i₂), the friction clutches (49, 50) are engagable at least under partial load and form a drive connection between the at least one countershaft (8, 9) and the output shaft (30) of the main group, in which a rotationally fixed connection of one loose wheel (14, 22) to the output shaft (30) of the main group is either formed or released.

20. The multi-group transmission according to claim 17, wherein a change-under-load device (54) has a friction clutch (55) and is arranged on a least a main transmission gear (i₁) and comprises an output component (56) that is rotationally fixed to the output shaft (30) of the main group and an input component (57) connected to a loose wheel (19) of the main transmission gear (i₁), such that the friction clutch (55) forms a drive connection, at least under partial load, between the at least one countershaft (8, 9) and the output shaft (30) of the main group, in which a rotationally fixed connection of the loose wheel (19) of the main transmission gear (i₁) to the output shaft (30) of the main group is either made or released.

21. The multi-group transmission according to claim 17, wherein a change-under-load device (59) is axially arranged between the two constants (iₖ₁, iₖ₂) of the splitter group (2″), the change-under-load claw clutch (60) is rotationally fixed to the transmission input shaft (17) is engagable at least under partial load to form a drive connection between the transmission input shaft (17) and the at least one countershaft (8, 9), in which a rotationally fixed connection between either a loose wheel (11) of the constant (iₖ₁) closest the drive motor (5), or a loose wheel (14) of the constant (iₖ₂) remote from the drive motor (5) and the transmission input shaft (17) is either formed or released.

22. The multi-group transmission according to claim 17, wherein a change-under-load device (61) with a change-under-load claw clutch (62) is axially arranged between the constant (iₖ₂) of the splitter group (2″) remote from the motor and a main transmission gear (i₂) and is connected to the output shaft (30) of the main group, such that the change-under-load claw clutch (62) is engagable, at least under partial load, and forms a drive connection between the at least one countershaft (8, 9) and the output shaft (30) of the main group, in which at least rotationally fixed connection between the output shaft (30) of the main group and either a loose wheel (14) of the constant (iₖ₂) remote from the drive motor (5), or a loose wheel (22) of the main transmission gear (i₂), is either formed or released.

23. The multi-group transmission according to claim 17, wherein a change-under-load device (63) is arranged at least on one main transmission gear (i₁) and comprises a change-under-load claw clutch (64) which is rotationally fixed to the output shaft (30) of the main group and is shiftable under load on at least one side, the change-under-load claw clutch (64) is engagable and forms a drive connection at least under partial load between the at least one countershaft (8, 9) and the output shaft (30) of the main group, in which a rotationally fixed connection of a loose wheel (19) of the main transmission gear (i₁) to the output shaft (30) of the main group is either formed or released.

24. A multi-group transmission of a motor vehicle comprising at least a main group and a range group (3′, 3″, 4), the range group (4) being designed as a planetary gearset and being positioned downstream of the main group (3′, 3″) and designed as a gear transmission;
a main group output shaft (30) being connected to a sun gear (34) of the range group (4) and a transmission output shaft (36) being connected to a planetary gear carrier (33) of the range group (4);
a starting element (7) coupling a drive motor (5) to a transmission input shaft (17);
a change-under-load device (16), designed as a friction clutch, being integrated into the range group (4) for engaging a traction-force-supporting direct gear, as an intermediate gear during a gearshift operation, and the change-under-load device (16) facilitates coupling of the transmission input shaft (17) to the transmission output shaft (36);
an input component (40), of the change-under-load device (16), being connected to the transmission input shaft (17) and an output component (41), of the change-under-load device (16), being connected to the planetary gear carrier (33) of the range group (4);
at least one change-under-load device (42, 48, 54, 59, 61, 63) engaging at least one gear (i₁, i₂, i₃) of the main group (3′, 3″) or at least one constant (iₖ₁, iₖ₂), located upstream of the main group (3′, 3″), to facilitate a gearshift under at least partial load.

25. A method for operating a multi-group transmission of a motor vehicle, in which traction-force-supporting means are activated during a gearshift operation, the method comprising the steps of:
engaging an intermediate gear with a change-under-load means (16) comprising a friction clutch to form a connection between a transmission input shaft (17) and a transmission output shaft (36);
maintaining at least partial engagement of a starting element (7) and operating the change-under-load means (16), in a slipping condition, to transmit torque of a drive motor (5) to the transmission output shaft (36);
adapting the speed of the drive motor (5) to a synchronous speed of a target gear; and
shifting under at least partial load at least one of an original gear and a target gear with at least one shiftable change-under-load device (42, 48, 54, 59, 61, 63) such that at least one of the original gear is disengaged and the target gear is engaged before at least one of the load has almost been relieved and the synchronous speed has almost been reached.
